(19) United States
(12) Patent Application Publication
(10) Pub. No.: US 2024/0338760 A1
(43) Pub. Date: Oct. 10, 2024

(54) METHOD AND SYSTEM FOR PROVIDING AUTO LOANS FOR RIDESHARE DRIVERS

(71) Applicants: David Colletti, Doylestown, PA (US); Paul Kostoff, Cincinnati, OH (US); Benjamin Spooner, Post Falls, ID (US); Yevgen Melnichenko, Orlando, FL (US)

(72) Inventors: David Colletti, Doylestown, PA (US); Paul Kostoff, Cincinnati, OH (US); Benjamin Spooner, Post Falls, ID (US); Yevgen Melnichenko, Orlando, FL (US)

(21) Appl. No.: 18/627,424

(22) Filed: Apr. 4, 2024

Related U.S. Application Data
(60) Provisional application No. 63/494,224, filed on Apr. 4, 2023.

(51) Int. Cl. G06Q 40/03; G06Q 50/43

(52) U.S. Cl. CPC G06Q 40/03; G06Q 50/43

(57) ABSTRACT

Computer-implemented methods and systems for offering auto loans to rideshare drivers based on improved models for underwriting and price and win rate optimization. Loan terms include weekly payments and ability to make payments easily via payment app or reminder messages provided. A telematics device attached to a vehicle to monitor rental payments in real time and communicate issues associated therewith with rideshare driver. Telematics device can disable vehicles ignition if loan goes into default.

### BACKGROUND

The current labor market is relying heavily on temporary and part-time positions filled by independent contractors and freelancers rather than full-time permanent employees (often referred to as the gig economy). Transportation network companies (TNC) such as Uber® and Lyft® have become very popular and are part of the gig economy. TNC's provide ride sharing applications that enable drivers and riders the ability to connect in order for the driver using their vehicle to provide transportation services to the rider. The drivers are independent contractors working for the TNC and can work at their discretion and accept only fairs that they are interested in. The drivers are paid a percentage of the fare that is collected by the TNC plus tips. In addition to individuals utilizing their vehicle to provide ride sharing, the gig economy also includes individuals using their vehicle to make deliveries (e.g., Uber Eats®, Door Dash®, FedEx®, Amazon®, UPS®, U.S. Postal Service®). As with the TNCs, the delivery drivers may work at their discretion and get paid based on, for example, how many deliveries they make.

Drivers may face challenges obtaining an auto loan due to a poor credit history. Drivers with poor credit history often rent their vehicle if they cannot obtain an auto loan. Renting a vehicle for ride sharing is expensive, costing drivers several hundreds of dollars a week. There is a need for a loan application process that considers the unique circumstances of ride share drivers when reviewing the applicant's qualifications for an auto loan. The use of their vehicles to provide these services increases the mileage on the vehicle and accordingly decreases the life of the vehicle. The life expectancy of the vehicles may be less than the typical term of a loan on the vehicle. Furthermore, the availability of the vehicle is directly related to the ability of the owner to make money and thus their ability to pay the loan. Accordingly, only shorter-term loans may be available for these vehicles and/or more up-front money may be required to obtain the loan. As such, financing vehicles to use for ride sharing and/or deliveries may be difficult. While renting vehicles may be an option, the cost of renting may be very high based on the mileage put on these vehicles.

There is a need in the automobile financing industry for a system and method for assessing the risk that a subprime borrower will default on an auto loan that considers the relative importance of variables beyond those considered in prior art underwriting models. Further, there is a need in the automobile financing industry for a system and method for price optimization and win probability in a competitive market. This needs to be accomplished in a manner that is transparent for the parties involved, particularly for rideshare drivers.

There is also a need method and system for providing drivers with loans for vehicles to be utilized in the ride sharing and delivery market that the drivers can afford. Furthermore, there is a need for a method and system that more accurately provides an indication of the likelihood that the driver will repay the loan. In addition, a method and system are needed to provide a fast and convenient way to make payments on the loan, track payment progress, and receive notifications about pending actions that may occur due to delinquent payments. Moreover, a method and system are needed that provides the ability to foreclose on delinquent loans in a timely manner.

### SUMMARY

The solution disclosed herein is a scalable system of robust machine learning (ML) models that make accurate predictions while dynamically adjusting to borrower features and market conditions. This is accomplished through the system's unique architecture and enhanced performance of the ML models. The disclosed models use large data sets to make predictions and discover unseen features and relationships between one or more features. The solution also provides a telematics component that provides real-time loan payment tracking and options for dealers to recover a vehicle in the event of default. The combination of these features adds transparency and accuracy throughout the auto loan process.

### DESCRIPTION OF FIGURES

The features and advantages of the various embodiments will become apparent from the following detailed description in which:

FIG. 1 shows a process flow for an example system, according to one embodiment.

FIG. 2 shows scope of training data used to train and validate a machine learning underwriting model, according to one embodiment.

FIG. 3 shows a process flow for an example price optimization and win probability model and graphical expression of a final output, according to one embodiment.

FIG. 4 shows a neural network structure used for graphing price optimization and win probability, according to one embodiment.

FIG. 5 is an example of how price and win probability can be expressed as a sigmoid relationship, according to one embodiment.

FIG. 6 shows an example of how an optimal win probability can be considered when pricing a loan, according to one embodiment.

### DETAILED DESCRIPTION

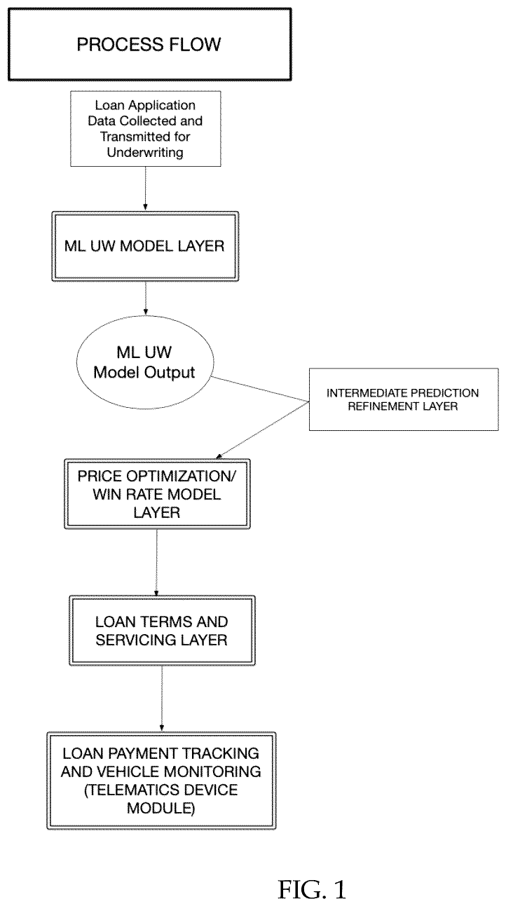

The disclosed invention requires dealerships teaming up with a loan company to offer this type of financing. FIG. 1 shows the process flow for the invention. The initial phase of the process is the underwriting stage. Often, prior to the driver looking for financing for a new vehicle, they have rented a vehicle through a rental platform. The rental platform may be the ridesharing company that they are driving for or may be a typical rental company.

The underwriting process may look for a minimum number (e.g., 26) of payments in order to attempt to get financing. While the rental payments are a part of the approval processes, they are not required. The driver then submits a prequalification loan application to a dealer. The driver may go to the dealer to prepare the application. Preferably, the driver can use a link on the car dealerships website to connect to the loan application that they can fill out on their own.

The application may ask the driver for some basic information related to their identity, address, income, and the like. The application includes standard acknowledgments and consents regarding, for example, the information in the loan being accurate, the fact that the information will be used to pull credit for the driver, and the fact that driver may be contacted at the provided contact information. The driver must agree to the acknowledgments and consents in order to submit the loan application. In addition, the application will include relevant disclosures applicable to different states and other regulatory requirements.

One aspect of the invention is an income verification model. The system asks the loan applicant to verify the applicant's income through a third-party bank transaction data connection company, such as Plaid. The applicant connects their bank information to the bank transaction data connection platform. The data is then shared securely with the prequalification system so that the applicant's income can be verified and further processed. After this information is collected, the ML UW process is employed.

### ML UW Model Layer

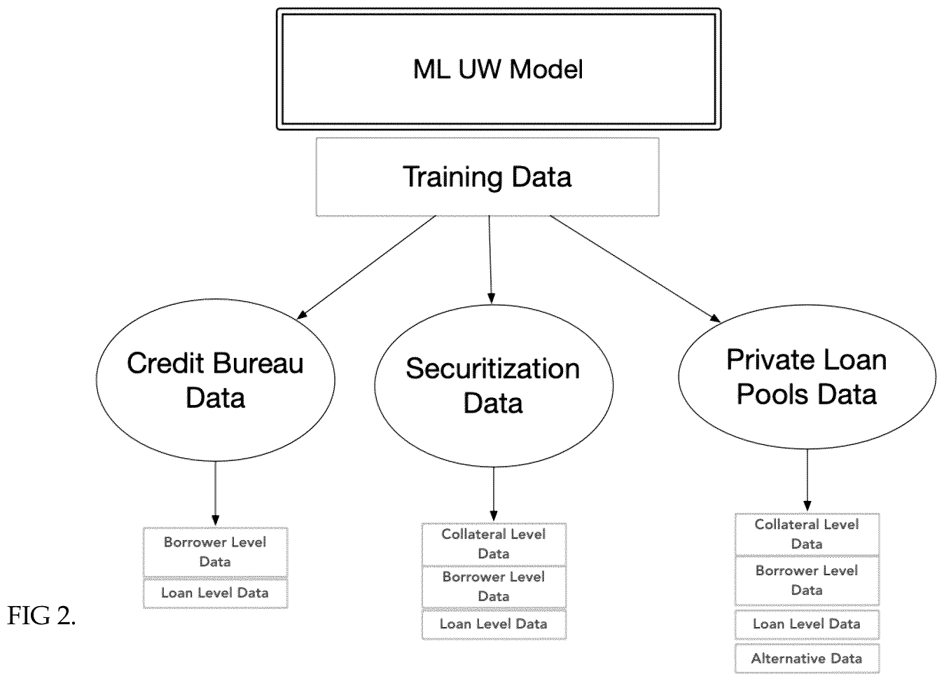

FIG. 2 shows the scope of information used to train the ML UW Model. The ML UW Model is trained and validated using data from a large number (e.g., approximately 7,500,000) of auto loan borrowers in the near subprime level. The data is collected from third-party credit bureaus and private loan pools. The data gathered from credit bureaus include data at the collateral level, borrower level and loan level. Data from private loan pools include collateral level, borrower level, loan level, and alternative data. Additional data processed is securitization data and includes data from a large amount of borrowers for all states.

Each data point has a different level of importance with respect to risk, and the disclosed methods and systems rely on a unique way to evaluate these levels of importance and improve model accuracy. In an auto financing approval model for subprime borrowers, the model may assign higher weights to features such as employment stability and payment history over a specific time period. Subprime borrowers with consistent employment histories and positive rental payment histories are viewed more favorably by lenders, as they demonstrate the ability to manage their finances responsibly despite their credit challenges. In the disclosed system, the importance of these features may be greater in the overall decision, even for borrowers with poor credit.

The disclosed alternative features UW ML model assigns different weights to different features based on the input data for the features. A change in the weight of one feature may affect the weights of other features. This dynamic method of varying the weights of one or more features based on inputs and then adjusting the weights of one or more other features based thereon can provide insight into the relative importance of a particular feature.

The base layer ML UW model employs gradient boosting machines (GBM). Gradient boosting is a machine learning technique that builds multiple decision trees sequentially, with each subsequent decision tree correcting the errors of the previous decision tree. GBMs iteratively minimizes a loss function by adding weak learners (decision trees) and focusing on the mistakes made by the previous trees. Initially, a base underwriting model is trained using gradient boosting techniques. This model takes input features related to borrower characteristics, loan details, marketing channel information, and historical conversion data.

The base underwriting model outputs two sets of predictions: probabilities of default or repayment for each borrower (for price optimization), and probabilities of conversion for each lead or applicant (for win rate estimation). The outputs from the ML UW Model are then used as the inputs for the Price Optimization/Win Rate Model.

### Intermediate Refinement Layer

An intermediate layer is then applied to refine the predictions made by the UW ML Model. A Monte Carlo simulation can be used to refine the predictions of an UW model, especially when considering individual borrower rent payment history and market conditions. The Monte Carlo simulation layer in the disclosed system incorporates historical data on the borrower's rent payment behavior. This may include information on the consistency, timeliness, and frequency of rent payments over time. Market conditions, such as changes in interest rates, housing prices, employment rates, and economic indicators, are also included as inputs to the simulation. These factors can influence the borrower's ability to make rent payments and, consequently, impact their creditworthiness.

For each input variable (e.g., rent payment history metrics, market conditions), probability distributions are defined based on historical data or expert judgment. These distributions capture the uncertainty and variability associated with each variable. For example, the distribution of rent payment consistency may follow a binomial distribution, while market conditions may be modeled using normal distributions or historical data-driven distributions.

The Monte Carlo simulation generates multiple scenarios by randomly sampling values from the defined probability distributions for each input variable. Each scenario represents a possible combination of borrower rent payment behavior and market conditions. For instance, in one scenario, the borrower may have a consistent rent payment history and favorable market conditions, while in another scenario, the borrower may have sporadic rent payments and adverse market conditions.

For each scenario generated by the Monte Carlo simulation, the UW model is applied to predict the borrower's creditworthiness or likelihood of default. By running the UW model across multiple scenarios, the simulation provides a range of possible outcomes, reflecting the uncertainty inherent in borrower rent payment behavior and market conditions. The predictions from the UW model in each scenario are aggregated or analyzed to derive refined estimates of credit risk or default probability.

The refined predictions obtained from the Monte Carlo simulation enable lenders to perform a more comprehensive risk assessment and make informed lending decisions. Lenders can evaluate the distribution of predicted credit risk across multiple scenarios, assess the impact of different rent payment histories and market conditions on borrower creditworthiness, and adjust lending policies or terms accordingly. Additionally, Monte Carlo simulations provide insights into the range of potential outcomes and the associated probabilities, allowing lenders to quantify and manage risk effectively.

By adding a Monte Carlo simulation as an intermediate layer considering individual borrower rent payment history and market conditions, lenders can enhance the accuracy and robustness of their credit risk assessments, leading to more informed lending decisions and improved portfolio management strategies.

### Price Optimization/Win Rate Model Layer

Neural networks are utilized for a price optimization and win rate model. Neural networks are deep learning models that consist of interconnected layers of nodes with learnable weights and activation functions. Neural networks learn complex patterns in data and can adjust the weights of features to minimize the error between predicted and actual outcomes.

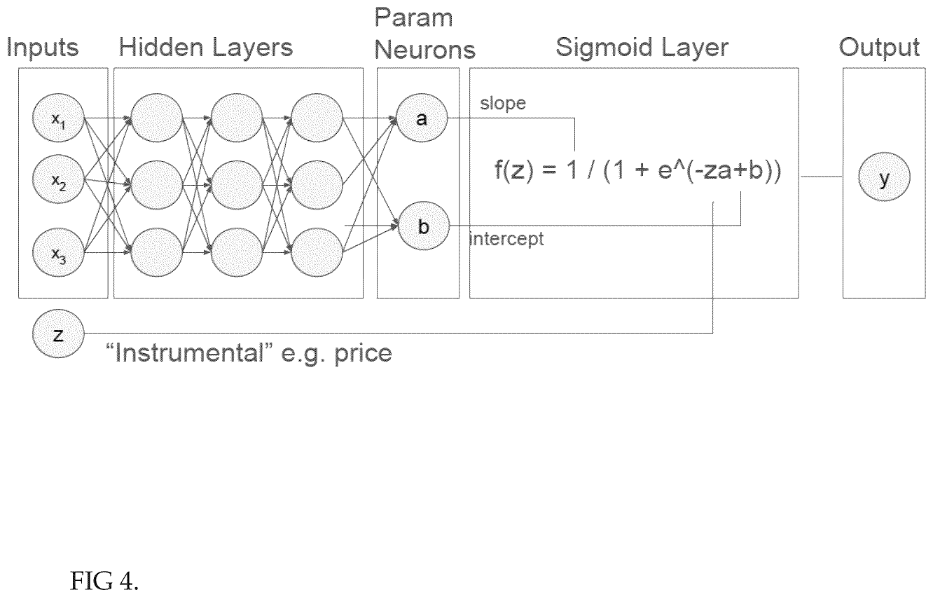

The neural network architecture for the Price Optimization/Win Rate Model (PO/WR Model) follows a dense feedforward structure, where each neuron in a layer is connected to every neuron in the subsequent layer (FIG. 4). These layers are often referred to as dense layers. Each neuron computes a weighted sum of its inputs, applies an activation function, and passes the result to the neurons in the next layer.

Additionally, linear bypass connections are introduced, allowing information to skip certain layers and flow directly to deeper layers. These linear bypass connections help mitigate issues, like the vanishing gradient problem, and facilitate the flow of information through the network.

In a dense feedforward network with a linear bypass, the skip connections are linear mappings, meaning that the input to a layer is added to its output without any non-linear activation function applied. This allows the network to learn to selectively pass information through the skip connections without introducing non-linear transformations that may degrade the signal.

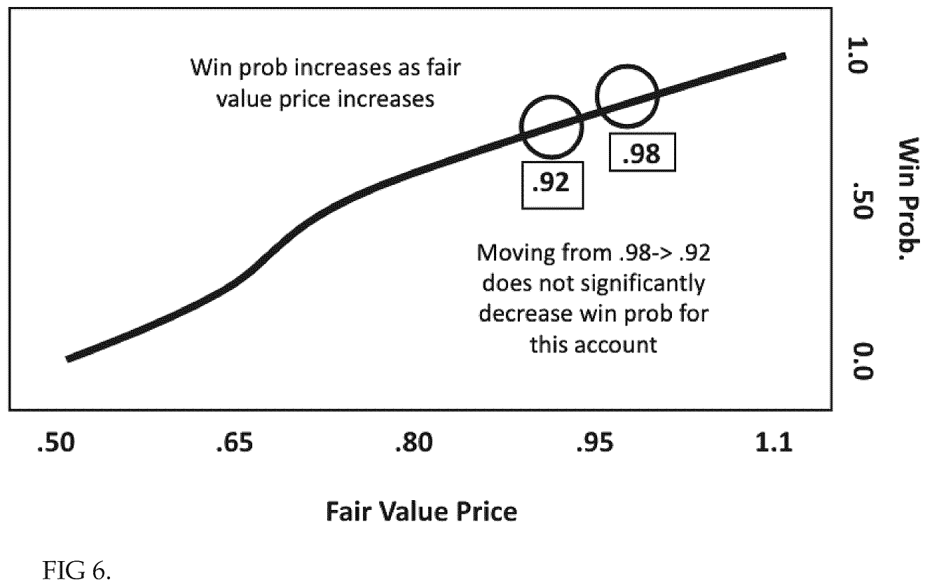

The PO/WR Model considers various factors to determine the optimal price and win rate. Win rate (WR) is the probability of whether or not the lender will “win” in competitive market, i.e., whether the lender will win the booking. For example, FIG. 6 shows the target WR may be between 0.92 and 0.98 is the desired value. The UW model uses the probability of default for each approval to dynamically calculate a dealer premium or discount price to a specified yield. This pricing optimization model is used to quickly adjust to market conditions. For instance, if an auto loan needs to be priced at 98% of par for a 10% yield, but the win probability model is confident that the lender can win the booking at 92% of par, the callback will be priced at 92%. This drives outsized returns for the lender.

Importantly, this PO/WR model is separate from the ML UW Model and the intermediate refinement model. This unique approach of differentiating the underwriting risk from market pricing is made possible by utilizing a well-formed price-to-win elasticity curve. This is accomplished by a specialized final layer.

The unique final layer translates dense nodes into neurons which act as the parameters for sigmoid functions. As shown in FIG. 4, The function is expressed as follows:

$$f ( z ) = 1 / ( 1 + {e}^{- za + b} )$$

Each sigmoid function is directly fed selected hold-out variables as the remaining z parameters. Hold-out variables (e.g., price) are features or inputs that are not directly processed by the network but are instead used as parameters for the sigmoid functions. This allows for explicit control over the behavior of the sigmoid functions based on external factors or domain knowledge.

By selecting specific hold-out variables and feeding them directly into the sigmoid functions, the network can enforce certain constraints or relationships between the input features and the output predictions. Each dense node output is translated into a parameter for a corresponding sigmoid function. These parameters determine the shape and behavior of the sigmoid functions. By using dense node outputs as parameters, the network effectively learns to control the behavior of the sigmoid functions based on the learned representations in the preceding layers.

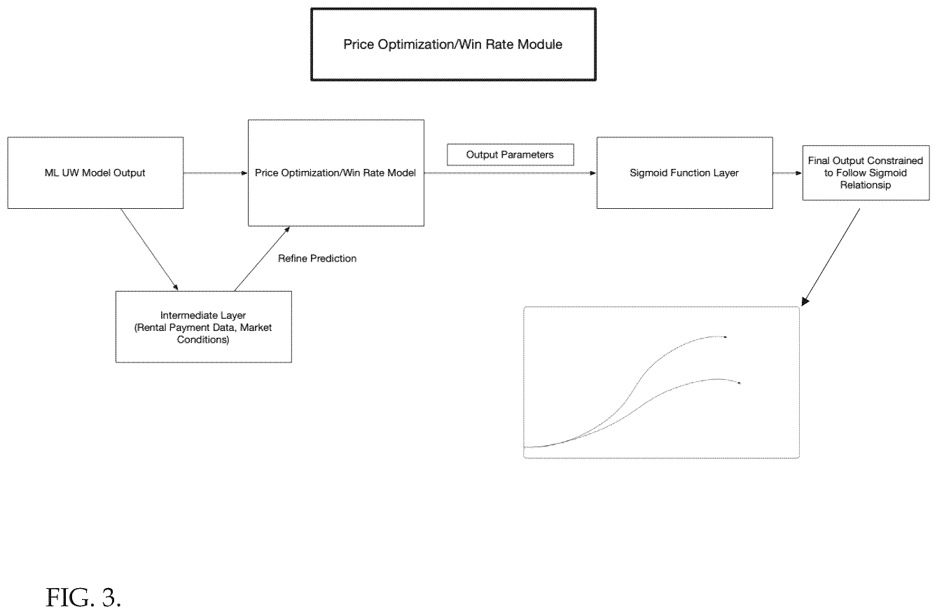

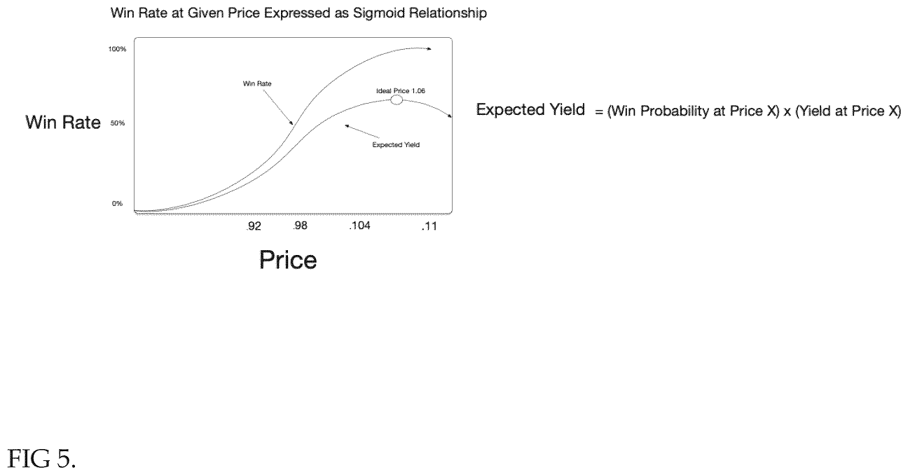

The result is a dense neural network with selected variables forced to obey sigmoid one-to-one function. FIGS. 3 and 5 shows the shape of the sigmoid relationship. This is especially important in the pricing and win rate optimization analysis because it guarantees positive behavior of the model with respect to price (e.g., that higher price always generates a higher win rate, but never a lower win rate).

In prior art methods and systems, sigmoid functions are commonly used as activation functions in hidden layers of neural networks. However, they tend to cause the vanishing gradient problem. The gradient problem occurs because as more layers using the sigmoid function are added, the gradient decreases exponentially. A small gradient means that the weights and biases of the initial layers will not be updated effectively with each training session. Without an interpretable relationship between optimum price and optimal win rate, as is the case in standard industry methods, pricing is set at win rates that are lower than optimal.

In standard neural networks, sigmoid functions are applied to the outputs of neurons in hidden layers. The sigmoid function introduces non-linearity to the network, allowing it to learn complex relationships between inputs and outputs. The output of each neuron after applying the sigmoid function typically represents the activation level or probability of the neuron firing given its inputs. Sigmoid functions are used in this way throughout the network, including in the output layer for binary classification tasks, where the output represents the probability of belonging to a certain class.

The disclosed invention uses a different approach by applying the sigmoid function (FIG. 4) to translate the dense nodes into parameters for sigmoid activation functions. In the described approach, sigmoid functions are not directly applied to the outputs of neurons in hidden layers. Instead, the final layer of the network generates parameters for sigmoid functions based on the outputs of preceding layers (dense nodes). These parameters are represented as “a” and “b” in FIG. 4. The parameters could include weights and biases that determine the shape and characteristics of sigmoid functions applied to the outputs. The outputs of the final layer are not the final predictions themselves but rather parameters that are then used to apply sigmoid functions to the preceding layer's outputs.

The disclosed system utilizes a unique architecture for a neural network with dense feedforward connections, linear bypass connections, and a unique final layer. The combination of dense feedforward connections, linear bypass connections, and the unique final layer results in a dense neural network where selected variables are forced to obey sigmoid one-to-one functions, as shown in FIG. 4.

Each selected variable influences the behavior of a specific sigmoid function, which in turn affects the output predictions of the network. This architecture allows for fine-grained control over the relationship between input features and output predictions, making it suitable for tasks where such control is desired or necessary. Overall, the described architecture offers a novel approach to constructing neural networks with specific constraints or relationships between input and output variables, leveraging the power of dense connections, linear bypasses, and sigmoid activation functions.

### Loan Terms and Servicing Layer

In addition to using the ML UW model to make predictions about default and cash flow, refining those by the intermediate layer, and using the UW outputs as inputs in the by the PO/WR model to predict an optimal price at the optimal win rate, the disclosed system applies a ML model to set competitive terms for a loan based on predictions of terms that may be offered by competitors. This model is built from a large number of loans across large securitizations.

### Telematics Device Module

The final component of the claimed system utilizes a telematics device attached to the vehicle for which a loan is provided. The driver can make the payments using an app on their phone associated with the loan. Additionally, the driver may be provided with reminder messages on their phone that includes a link to enable a payment to be made.

The driver may also make a payment in other fashions including calling in a payment or logging in to their account details on a computer. Once the payment is made the loan company will update the loan details to reflect the payment. The driver will then have access to the updated information, including payments made, balance and next payment. The driver may make partial payments (e.g., daily) if they desire. The loan will be updated to reflect the partial payment and the driver can access details regarding payments made and balance of the weekly payment that is due.

On a monthly basis, the loan company provides the credit bureaus with payment history and also forwards the associated dealer with its monthly participation payment. Payment data may be used to further train the ML models for improved accuracy and insight. When a driver misses one or more weekly payments, initially the loan company provides the dealer with notifications of delinquencies. The notification may be if a payment is not made on the due date or may be if the loan is a certain number of days past due (e.g., 2, 3 days). The notification period may be standard for all dealers, may be dealer specific or may be based on state and/or local rules associated with loans. At the appropriate time the collection process begins. The terms of collection process associated with default on the loan are state/local specific.

The process may include warnings, deactivation of the vehicle using the telematics device and then actual repossession. The timing of the various activities may be state/local specific. For example, some states may allow a warning to be issued as soon as the loan is past due while others may require a grace period. Some states may allow actions with regard to taking affirmative steps a few days (e.g., 3) after late payment while others may require longer (e.g., 7).

The telematics device may be capable of wireless communications with different aspects of the system to initiate warnings. At an appropriate time, the location of the vehicle is provided to a repossession company so the repossession company can obtain the vehicle. Once the vehicle is repossessed the vehicle is returned to the dealer and the dealer reimburses the loan company for the remainder of the loan.

The driver makes a payment (e.g., utilizing their phone). The payment is processed by a payment processor (e.g., Repay). The payment processor provides the payment to the loan company who deposits the money into the bank. Once the payment is confirmed the company controlling the telematics device is notified and then the appropriate instructions are provided to the telematics device in the car. The instructions to the telematics device may be that the payment was made so that the device does not provide any notifications or provides a notification that the loan is current.

If a payment is not made, the loan company will not be informed and accordingly the loan company will know that the loan is delinquent. Likewise, if the telematics system is not informed it will know the loan is delinquent. Alternatively, the loan system may notify the telematics system. The telematics system may be programmed with the rules associated with the state/local regarding notices and actions on delinquent loans. The telematics system may provide instructions to the telematics device about actions that should be taken with regard to the delinquent loan (e.g., provide notices, disable vehicle). If the vehicle is disabled, there may be actions that the driver may take to obtain additional time to utilize the vehicle. For example, the driver may be able to utilize an app to turn off the deactivation of the vehicle for a defined period of time (e.g., 24 hours). Once payment is made the system can reset the telematics device to indicate that the loan is again current.

The telematics device may be easily installed in the vehicle, where proper installation is verified. The device is tamper resistant and notification of an attempt to transfer is provided to the system. The device can be activated in real time with regard to notifications or to deactivate the ignition of the vehicle. The device can be managed via the web. Advanced reporting is available regarding the vehicle being towed, having low power and the status of the device. The system may integrate with various impound lots so that it can be notified if any of the vehicles are in an impound lot.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

1. A computer-implemented method for underwriting and pricing of loans for rideshare vehicles, the method comprising:
providing a loan pre-qualification application to a rideshare driver;
collecting credit and rental history information from the rideshare driver;
collecting information from third parties about the rideshare driver;
utilizing a base layer underwriting model to make a default risk prediction based on the information collected from the rideshare driver and the third parties;
refining the default risk prediction from the base layer underwriting model with available alternative data about the rideshare driver including the rental history and any specific business conditions;
approving or denying a loan based on the risk prediction;
optimizing the price of a loan and win probability at a desired yield by employing a price optimization and win probability model based on the refined outputs of the underwriting model, wherein the price optimization and win probability model comprises
a dense feedforward neural network with a linear bypass; and
a final layer that translates dense nodes in hidden layers in the dense feedforward neural network into parameters for a sigmoid function and feeding hold-out variables into the sigmoid function to generate a final output constrained to follow the sigmoid relationship;
determining the optimal price and optimal win probability from the final output constrained to follow the sigmoid relationship; and
utilizing a loan terms model to set loan terms that are market competitive.

2. The method of claim 1, further comprising
tracking parameters about the loan including payment schedule and payments made;
enabling the rideshare driver ability to make payments; and
updating the loan information regarding payments.

3. The method of claim 2, further comprising installing a telematics device on the vehicle financed with the loan, wherein the telematics device is capable of tracking location of the vehicle, communicating with the rideshare driver and disabling ignition of the vehicle in event of loan default.

4. The method of claim 1, wherein the loan terms include weekly payments.

5. The method of claim 1, wherein the collecting credit and rental history information from the rideshare driver includes the rideshare driver granting bank account access to a third-party financial services company.
